(19) United States
(12) Patent Application Publication
(10) Pub. No.: US 2026/0210732 A1
(43) Pub. Date: Jul. 23, 2026

(54) SYSTEM AND METHOD FOR CONTROLLING CONNECTIVITY OF FEATURE LINES OF JUNCTION NETWORKS

(71) Applicant: HERE Global B.V., Eindhoven (NL)

(72) Inventor: Zhenhua ZHANG, Chicago, IL (US)

(21) Appl. No.: 18/990,325

(22) Filed: Dec. 20, 2024

(51) Int. Cl. G01C 21/00

(52) U.S. Cl. CPC G01C 21/3819

(57) ABSTRACT

A system for controlling connectivity of feature lines within junction networks is disclosed. The system obtains feature line data of each of a plurality of feature lines associated with a geographical region and selects a pair of adjacent feature lines from the plurality of feature lines based on the feature line data, the pair of adjacent feature lines comprising a first feature line and a second feature line. Based on matched segment data associated with a matched segment between the first feature line and the second feature line, the system further determines a set of connectivity attributes associated with the pair of adjacent feature lines and a junction location associated with the first feature line and the second feature. The system further controls a connectivity of the first feature line and the second feature line within the matched segment based on the set of connectivity attributes and the junction location.

### TECHNOLOGICAL FIELD

The present disclosure generally relates to processing of feature lines for road mapping, and more particularly relates to controlling connectivity of feature lines associated with junction networks.

### BACKGROUND

Navigation systems widely utilize feature line data to provide navigation capabilities (such as auto cruise control operations, collision avoidance operations, or route recommendation operations) to vehicles, leading to an improved user experience of users of the vehicles. The feature line data includes feature lines associated with trajectories of the vehicles in a geographical region. The feature lines may indicate a linear representation of one or more features in the geographical region. The navigation systems may obtain the feature line data for identifying various navigation related entities, such as road objects, links, lane markings, road segments, road geometries, and the like. However, the feature line data may include inaccuracies, specifically, due to a connection or a splitting of the linear features around intersection locations. In an example, an intersection, i.e., a splitting, a merging or a junction at an intersection location may lead to a discontinuity in the feature lines. Further, a performance of the navigation systems can decrease due to utilization of the inaccurate feature line data for providing the navigation capabilities to vehicles. In an example, the navigation systems may generate incorrect geospatial map data layer, route recommendations, and/or directions based on the inaccurate feature lines, leading to inconvenience for the users of the vehicles.

Therefore, there is a need for systems and methods for generating accurate feature lines around intersection locations to overcome the aforesaid challenges.

### BRIEF SUMMARY OF SOME EXAMPLE EMBODIMENTS

A system, a method and a computer programmable product are provided for controlling connectivity of feature lines within junction networks.

In one aspect, a method for controlling connectivity of feature lines is provided. The method comprises obtaining feature line data of each of a plurality of feature lines associated with a geographical region. The method further comprises selecting a pair of adjacent feature lines from the plurality of feature lines based on the feature line data. The pair of adjacent feature lines comprising a first feature line and a second feature line. The method further comprises determining matched segment data associated with a matched segment between the first feature line and the second feature line. A distance between the first feature line and the second feature line within the matched segment is less than a threshold. The method further comprises determining a set of connectivity attributes associated with the pair of adjacent feature lines based on the matched segment data. The method further comprises determining a junction location associated with the first feature line and the second feature line based on the matched segment data. The method further comprises controlling a connectivity of the first feature line and the second feature line within the matched segment based on the set of connectivity attributes and the junction location.

In an embodiment, the method further comprises identifying an end location associated with the first feature line. The method further comprises determining a distance between the end location of the first feature line and a body location of the second feature line. The body location corresponds to a closest point of the second feature line from the end location of the first feature line. The method further comprises determining the junction location based on the distance, the end location of the first feature line and the body location of the second feature line. The method further comprises updating a part of at least one of the first feature line, or the second feature line based on the set of connectivity attributes and the junction location. The part corresponds to the matched segment.

In an embodiment, the method further comprises determining geometry data associated with each of one or more geometries within the geographical region based on the feature line data. The method further comprises identifying a geometry from the one or more geometries associated with each of the pair of adjacent feature lines based on the feature line data and the geometry data. The method further comprises identifying at least one nearby geometry for each of the one or more geometries based on the geometry data. The at least one nearby geometry is selected from the one or more geometries. The method further comprises determining a set of geometry parameters for each of the one or more geometries based on the corresponding at least one nearby geometry. The method further comprises determining whether each of the one or more geometries is associated with a junction network based on the corresponding set of geometry parameters. The method further comprises controlling the connectivity of the first feature line and the second feature line based on the corresponding geometry and the determination.

In an embodiment, each of the pair of adjacent feature lines is associated with a first geometry from the one or more geometries. The method further comprises determining the first geometry from the one or more geometries to be associated with the junction network based on the set of geometry parameters associated with the first geometry. The method further comprises preventing the connectivity of the first feature line and the second feature line associated with the first geometry of the junction network at the at least one intersection point.

In an embodiment, the first feature line is associated with a first geometry from the one or more geometries and the second feature line is associated with a second geometry from the one or more geometries. The method further comprises determining the first geometry and the second geometry to be associated with the junction network based on a set of geometry parameters associated with the first geometry and a set of geometry parameters associated with the second geometry. The method further comprises determining, using a machine learning (ML) model, a connectivity condition for controlling the connectivity of the matched segment based on the set of connectivity attributes. The method further comprises connectivity the first feature line and the second feature line within the matched segment based on the connectivity condition.

In an embodiment, the connectivity condition corresponds to one of a first connectivity condition associated with removing one of a part of the first feature line within the matched segment or a part of the second feature line within the matched segment, or a second connectivity condition associated with an extension of at least one of the part of the first feature line, or the part of the second feature line within the matched segment to connect the first feature line and the second feature line.

In an embodiment, at least one of the pair of adjacent feature lines is associated with a first geometry from the one or more geometries. The method further comprises determining the first geometry from the one or more geometries to not be associated with the junction network based on the set of geometry parameters associated with the first geometry. The method further comprises determining a distance between the first feature line and the second feature line. The method further comprises controlling the connectivity of the first feature line and the second feature line associated with the first geometry based on a determination of a distance between the first feature line and the second feature line to be less than the threshold.

In an embodiment, the one or more geometries are associated with at least one of: an intersection geometry, a turning geometry, a splitting geometry, a connectivity geometry, or a straight geometry.

In an embodiment, wherein the junction network is associated with at least one of the intersection geometry, the turning geometry, the splitting geometry, or the connectivity geometry.

In an embodiment, wherein the first feature line is associated with the straight geometry and the second feature line is associated with at least one of: the intersection geometry, the turning geometry, the splitting geometry, or the connectivity geometry.

In an embodiment, the method further comprises obtaining map data associated with the geographical region. The method further comprises segmenting each of the plurality of feature lines into one or more portions based on the feature line data. The method further comprises identifying the one or more geometries within the geographical region based on the map data, the feature line data and the segmentation. The method further comprises associating each of the one or more portions of each of the plurality of feature lines with one of the one or more geometries.

In an embodiment, the geometry data comprises at least one of lateral offset data associated with each of the one or more geometries, orientation data associated with each of the one or more geometries, or elevation data associated with each of one or more geometries.

In another aspect, a system for controlling connectivity of feature lines within junction networks is provided. The system comprises a memory configured to store computer executable instructions, and one or more processors configured to execute the instructions to obtain feature line data of each of a plurality of feature lines associated with a geographical region. The one or more processors are further configured to select a pair of adjacent feature lines from the plurality of feature lines based on the feature line data. The pair of adjacent feature lines comprising a first feature line and a second feature line. Further, the pair of adjacent feature lines having at least one intersection point. The one or more processors are further configured to determine matched segment data associated with a matched segment between the first feature line and the second feature line based on the at least one intersection point. Further, a distance between the first feature line and the second feature line within the matched segment is less than a threshold. The one or more processors are further configured to determine a set of connectivity attributes associated with the pair of adjacent feature lines based on the matched segment data. The one or more processors are further configured to control a connectivity of the first feature line and the second feature line within the matched segment based on the set of connectivity attributes.

In an embodiment, to control the connectivity of the first feature line and the second feature line within the matched segment, the one or more processors are further configured to update a part of at least one of the first feature line, or the second feature line based on the set of connectivity attributes. The part corresponds to the matched segment.

In an embodiment, the one or more processors are further configured to determine geometry data associated with each of one or more geometries within the geographical region based on the feature line data. The one or more processors are further configured to identify a geometry from the one or more geometries associated with each of the pair of adjacent feature lines based on the feature line data and the geometry data. The one or more processors are further configured to identify at least one nearby geometry for each of the one or more geometries based on the geometry data. Further, at least one nearby geometry is selected from the one or more geometries. The one or more processors are further configured to determine a set of geometry parameters for each of the one or more geometries based on the corresponding at least one nearby geometry. The one or more processors are further configured to determine whether each of the one or more geometries is associated with a junction network based on the corresponding set of geometry parameters. The one or more processors are further configured to control the connectivity of the first feature line and the second feature line based on the corresponding geometry and the determination.

In an embodiment, each of the pair of adjacent feature lines is associated with a first geometry from the one or more geometries. The one or more processors are further configured to determine the first geometry from the one or more geometries to be associated with the junction network based on the set of geometry parameters associated with the first geometry. The one or more processors are further configured to prevent the connectivity of the first feature line and the second feature line associated with the first geometry of the junction network at the at least one intersection point.

In an embodiment, the first feature line is associated with a first geometry from the one or more geometries and the second feature line is associated with a second geometry from the one or more geometries. The one or more processors are further configured to determine the first geometry and the second geometry to be associated with the junction network based on a set of geometry parameters associated with the first geometry and a set of geometry parameters associated with the second geometry. The one or more processors are further configured to determine, using a machine learning (ML) model, a connectivity condition for controlling the connectivity of the matched segment based on the set of connectivity attributes. The one or more processors are further configured to connect the first feature line and the second feature line within the matched segment based on the connectivity condition.

In an embodiment, the connectivity condition corresponds to one of a first connectivity condition associated with removing one of a part of the first feature line within the matched segment or a part of the second feature line within the matched segment, or a second connectivity condition associated with an extension of at least one of the part of the first feature line, or the part of the second feature line within the matched segment to connect the first feature line and the second feature line.

In an embodiment, at least one of the pair of adjacent feature lines is associated with a first geometry from the one or more geometries. The one or more processors are further configured to determine the first geometry from the one or more geometries to not be associated with the junction network based on the set of geometry parameters associated with the first geometry. The one or more processors are further configured to determine a distance between the first feature line and the second feature line. The one or more processors are further configured to control the merging of the first feature line and the second feature line associated with the first geometry based on a determination of a distance between the first feature line and the second feature line to be less than the threshold.

In yet another aspect, computer programmable product comprising a non-transitory computer readable medium having stored thereon computer executable instructions, which when executed by one or more processors, cause the one or more processors to carry out operations for controlling connectivity of feature lines, the operations comprise obtaining feature line data of each of a plurality of feature lines associated with a geographical region. The operations further comprise selecting a pair of adjacent feature lines from the plurality of feature lines based on the feature line data. The pair of adjacent feature lines comprising a first feature line and a second feature line. Further, the pair of adjacent feature lines having at least one intersection point. The operation further comprise determining matched segment data associated with a matched segment between the first feature line and the second feature line based on the at least one intersection point. Further, a distance between the first feature line and the second feature line within the matched segment is less than a threshold. The operation further comprise determining a set of connectivity attributes associated with the pair of adjacent feature lines based on the matched segment data. The operation further comprise controlling a connectivity of the first feature line and the second feature line within the matched segment based on the set of connectivity attributes.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 is a diagram that illustrates a network environment for controlling a connectivity of feature lines within a junction network, in accordance with an embodiment of the disclosure;

FIG. 2 illustrates a block diagram of the system of FIG. 1, in accordance with an embodiment of the disclosure;

FIG. 3A is a diagram that illustrates a first exemplary environment for controlling connectivity of the feature lines within the junction networks, in accordance with an embodiment of the disclosure;

FIG. 3B is a diagram that illustrates an implementation of a machine learning model for controlling connectivity of the feature lines within the junction networks, in accordance with an embodiment of the disclosure;

FIG. 4 illustrates a flowchart for implementation of an exemplary method for controlling connectivity of the feature lines within the junction networks, in accordance with an embodiment of the disclosure;

FIG. 5A is a diagram that illustrates a second exemplary environment for controlling connectivity of the feature lines within the junction networks, in accordance with an embodiment of the disclosure;

FIG. 5B and FIG. 5C are diagrams that illustrates a third exemplary environment for controlling connectivity of the feature lines within the junction networks, in accordance with an embodiment of the disclosure;

FIG. 5D and FIG. 5E are diagrams that illustrates the third exemplary environment for controlling connectivity of the feature lines within the junction networks, in accordance with an embodiment of the disclosure;

FIG. 6A and FIG. 6B are diagrams that illustrates a fourth exemplary environment for controlling connectivity of the feature lines within the junction networks, in accordance with an embodiment of the disclosure;

FIG. 7A and FIG. 7B are diagrams that illustrates a fifth exemplary environment for controlling connectivity of the feature lines within the junction networks, in accordance with an embodiment of the disclosure; and

FIG. 8 illustrates a flowchart for implementation of another exemplary method for controlling connectivity of the feature lines within the junction networks, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

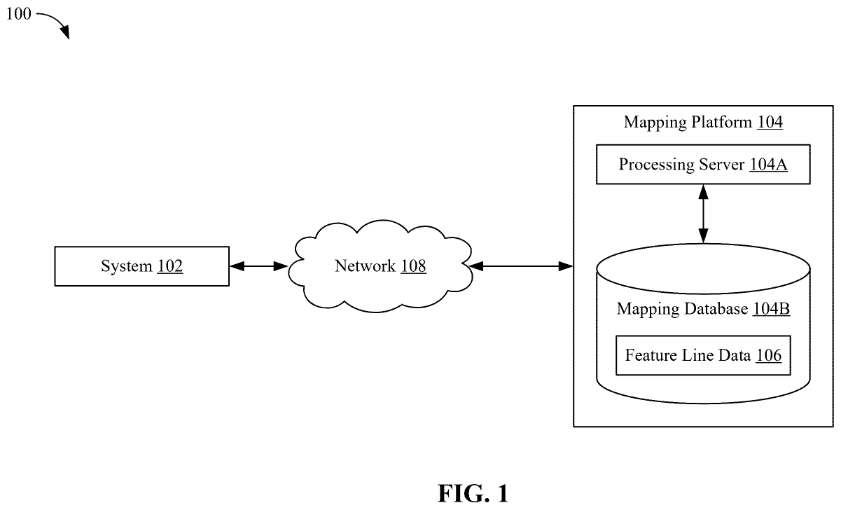

FIG. 1 is a diagram that illustrates a network environment for controlling connectivity of feature lines within junction networks, in accordance with an embodiment of the disclosure. The network environment 100 includes a system 102, a mapping platform 104, and a network 108. The mapping platform 104 may include a processing server 104A and a mapping database 104B. In an embodiment, the mapping database 104B may be configured to store feature line data 106 of each of a plurality of feature lines associated with a geographical region. The geographical region may correspond to a specific area of the Earth's surface having one or more physical features (such as a climate, a terrain, or water bodies). In an example embodiment, the geographical region may include a road segment, a set of lane segments associated with the road segment, or a set of link segments associated with the road segment. In an embodiment, a set of vehicles may be traveling in the geographical region (such as on the road segment in the geographical region). Each feature line of the plurality of feature lines may be indicative of a lane marking associated with the set of lane segments for the corresponding vehicles of the set of vehicles. Additionally or alternatively, each feature line of the plurality of feature line may include a plurality of location points of the lane marking associated with the set of lane segments.

In an embodiment, the system 102 may include suitable logic, circuitry, interfaces, and/or code that may be configured to obtain the feature line data 106 of each of the plurality of feature lines associated with the geographical region. In an example embodiment, the system 102 may be the processing server 104A of the mapping platform 104 and therefore may be co-located with or within the mapping platform 104. In another embodiment, the system 102 may be embodied as a cloud-based service, a cloud-based application, a cloud-based platform, a remote server-based service, a remote server-based application, a remote server-based platform, or a virtual computing system. In yet another example embodiment, the system 102 may be an OEM (Original Equipment Manufacturer) cloud. The OEM cloud may be configured to anonymize any data received by the system 102, such as data associated with the feature line data 106, before using the data for further processing, such as before sending the data to the mapping database 104B. For an example, anonymization of the data may be done by the mapping platform 104.

The mapping platform 104 may include suitable logic, circuitry, and interfaces that may be configured to store one or more map attributes and sensor data associated with traffic on the set of lane segments. The mapping platform 104 may be configured to store and update map data indicating the traffic data along with other map attributes, road attributes, and traffic entities, in the mapping database 104B. The mapping platform 104 may include techniques related to, but not limited to, geocoding, routing (multimodal, intermodal, and unimodal), clustering algorithms, machine learning in location-based solutions, natural language processing algorithms, and artificial intelligence algorithms. Data for different modules of the mapping platform 104 may be collected using a plurality of technologies including, but not limited to drones, sensors, connected cars, cameras, probes, and chipsets. In some embodiments, the mapping platform 104 may be embodied as a chip or chip set. In other words, the mapping platform 104 may include one or more physical packages (such as chips) that include materials, components, and/or wires on a structural assembly (such as a baseboard).

In some example embodiments, the mapping platform 104 may include the processing server 104A for carrying out the processing functions associated with the mapping platform 104 and the mapping database 104B for storing the map data. In an embodiment, the processing server 104A may include one or more processors configured to process requests received from the system 102. The processors may fetch sensor data and/or map data from the mapping database 104B and transmit the same to the system 102 in a format suitable for use by the system 102.

Continuing further, the mapping database 104B may include suitable logic, circuitry, and interfaces that may be configured to store the feature line data 106, which may be collected from the set of vehicles. In an embodiment, the feature line data 106 may include, but is not limited to, latitude information (such as a latitude coordinate) associated with each location point of the plurality of location points, longitude information (such as a longitude coordinate) associated with each location point of the plurality of location points, temporal information (such as timestamps) associated with each location point of the plurality of location points, navigation information (such as a speed) associated with each vehicle of the set of vehicles at each location point of the plurality of location points. In an example embodiment, the latitude coordinates, may be, for example, 40.7128 degrees North, 34.0522 degrees North, or 51.5074 degrees North. In an example embodiment, the longitude coordinates, may be, for example, 74.0060 degrees West, 118.2437 degrees West, or 151.2093 degrees West. In an example embodiment, the timestamps may correspond to “30 Aug., 2024 18:00”. In an example embodiment, the speed may be, for example, but is not limited to, 25 kilometer per hour (K/hr), 30 K/hr, or 50 K/hr.

In accordance with an embodiment, the feature line data 106 may be updated in real-time or near real-time such as within a few seconds, a few minutes, or on an hourly basis, to provide accurate and up-to-date feature line data. In an embodiment, the feature line data 106 may be collected from one or more sensors that may inform the mapping platform 104 or the mapping database 104B of the plurality of features lines associated with the geographical region. The one or more sensors may include, but are not limited to, motion sensors, inertia sensors, image capture sensors, proximity sensors, LiDAR sensors, and ultrasonic sensors may be used to collect the sensor data. The gathering of massive quantities of crowd-sourced data may facilitate the accurate modeling and mapping of an environment, whether it is a road link or a link within a structure, such as in an interior of a multi-level parking structure.

The mapping database 104B may further be configured to store the traffic-related data and road topology and geometry-related data for a road network as the map data. The map data may also include cartographic data, routing data, and maneuvering data. The map data may also include, but is not limited to, locations of intersections, diversions to be caused due to accidents, congestions or constructions, suggested roads, or links to avoid, and an estimated time of arrival (ETA) depending on different links. In accordance with an embodiment, the mapping database 104B may be configured to receive the map data including the road topology and geometry-related attributes related to the road network from external systems, such as one or more of background batch data services, streaming data services, and third-party service providers, via the network 108.

In accordance with an embodiment, the map data stored in the mapping database 104B may further include data about changes in traffic situations registered by GPS provider(s), such as, but not limited to, incidents, road repairs, heavy rains, snow, fog, time of day, day of a week, holiday or other events which may influence the traffic condition of a link segment.

In some embodiments, the mapping database 104B may further store historical probe data for events (such as, but not limited to, traffic incidents, construction activities, scheduled events, and unscheduled events) associated with Point of Interest (POI) data records or other records of the mapping database 104B.

For example, the data stored in the mapping database 104B may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as a user equipment. The navigation-related functions may correspond to vehicle navigation, pedestrian navigation, navigation to a favored parking spot, or other types of navigation. While example embodiments described herein generally relate to vehicular travel, example embodiments may be implemented for bicycle travel along bike paths, boat travel along maritime navigational routes, etc. The compilation to produce the end-user databases may be performed by a party or entity separate from the map developer. For example, a customer of the map developer, such as a navigation device developer or other end user device developer, may perform compilation on the received mapping database 104B in a delivery format to produce one or more compiled navigation databases.

In some embodiments, the mapping database 104B may be a master geographic database configured on the side of the system 102. In accordance with an embodiment, the mapping database 104B may represent a compiled navigation database that may be used in or with end-user devices to provide navigation instructions based on the traffic data, the traffic conditions, speed adjustment, ETAs, and/or map-related functions to navigate through the intersection connected links on the route.

In some embodiments, the map data may be collected by end-user vehicles (such as the set of vehicles) which use vehicles on-board one or more sensors to detect data about various entities such as road objects, lane markings, links, and the like. These vehicles are also referred to as probe vehicles and form an alternate form of data source for map data collection, along with ground truth data. Additionally, data collection mechanisms like remote sensing, such as aerial or satellite photography may be used to collect the map data for the mapping database 104B.

In an embodiment, the mapping database 104B may be configured to store lane and intersection data associated with the geographical region. The map data may represent links in the route, pedestrian lane, or areas in addition to or instead of the vehicle lanes. The lanes and intersections may be associated with attributes, such as geographic coordinates, street names, lane identifiers, lane segment identifiers, lane traffic direction, address ranges, speed limits, turn restrictions at intersections, and other navigation-related attributes, as well as POIs, such as fueling stations, hotels, restaurants, museums, stadiums, offices, auto repair shops, buildings, stores, and parks. The mapping database 104B may additionally include data about places, such as cities, towns, or other communities, and other geographic features such as, but not limited to, bodies of water, and mountain ranges.

The network 108 may be wired, wireless, or any combination of wired and wireless communication networks, such as cellular, Wi-Fi, internet, local area networks, or the like. In some embodiments, the network 108 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, international telecommunication union (ITU) -international mobile communications (IMT) 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In an embodiment, the obtained feature line data 106 and the sensor data for each vehicle of the set of vehicles may be utilized for an identification of a geometry associated with the road segment. The geometry may be indicative of at least one of a size of the road segment, a shape of the road segment, a location of the road segment or a width of the road segment. In an embodiment, the obtained feature line data 106 and the sensor data may be aggregated to determine the geometry associated with the road segment. Specifically, one or more geometries may be determined based on the obtained feature line data 106 and the sensor data. Each geometry of the one or more geometries may be associated with a lane segment of the set of lane segments. Further, the set of lane segments may be associated with the road segment. The geometry associated with the lane segment of the set of lane segments may be indicative of at least a size of the lane segment, a shape of the lane segment, a location of the lane segment, or a width of the lane segment. Further, each geometry of the one or more geometries may be connected d to identify the geometry associated with the road segment. In an embodiment, the connectivity of the one or more geometries may be referred to as “stateful conflation”. In an embodiment, the geometry associated with road segment may be determined based on a similarity between a lateral offset of the one or more geometries, an orientation of the one or more geometries, or an elevation of the one or more geometries. The determination of the geometry associated with the road segment may allow for a determination of the plurality of feature lines, a determination of driving behavior of the users of the set of vehicles in the geographical region, and a determination of a road mapping for the road segment.

However, there exist challenges associated with the connectivity of the one or more geometries with identical locations and orientations around intersection locations (such as roundabouts or ramps).

In an example embodiment, the plurality of feature lines may include a first feature line and a second feature line. Further, a first geometry and a second geometry may be associated with the first feature line and the second feature line, respectively. A distance between a location of a first geometry of the one or more geometries and a location of a second geometry of the one or more geometries is less than a first threshold (such as 2 meters, 4 meters, 6 meters, or 8 meters). Further, a difference between an orientation of the first geometry and an orientation of the second geometry is less than a first orientation threshold. To that end, identical locations and orientations of the first geometry and the second geometry may lead to challenges in determination whether to connect the first geometry with the second geometry for the determination of the geometry associated with the road segment or not. In another example embodiment, the first geometry may intersect another geometries of the one or more geometries at a plurality of locations that may lead to challenges in a determination of a splitting location, or a connectivity location associated with the first geometry. Additionally or alternatively, the first geometry may be skewed (distorted) due to a connectivity of the first geometry with another geometries of the geometries at the splitting location and the connectivity location. In yet another example embodiment, the identical locations and the orientations of the first geometry and the second geometry may further lead to challenges in determination whether to connect the first geometry and the second geometry at a junction network around the intersection location. In an example, the junction network may form a mini-network. Although the present disclosure describes that the junction network or the mini-network is formed of the first geometry and the second geometry, however, this should not be construed as a limitation. In other examples, the junction network or the mini-network may include three or more geometries. The junction network may correspond to at least one portion of the geographical region around the intersection location. The one or more geometries (such as the first geometry and the second geometry) may be associated with the junction network. In an embodiment, the one or more geometries may include redundant geometries that may further lead to challenges in determination whether to connect the one or more geometries. In order to address aforementioned challenges, the system 102 may control the connectivity of the first feature line and the second feature line based on an association of the one or more geometries with the junction network.

In another example embodiment, the first geometry and the second geometry may correspond to a straight geometry and a turning geometry, respectively. Additionally, a length of a matched segment between the first feature line and the second feature line is greater than a first length. Further, a distance between a part of the first feature line and the second feature line within the matched segment is less than a first distance. To that end, the connectivity of the first geometry and the second geometry may lead to generation of the right-skewed segments. The right-skewed segments may be indicative of a distortion associated with the connectivity of the part of the first feature line and the second feature line. In order to address challenges associated with the generation of the right-skewed segments, the system 102 may prevent the connectivity of the first feature line and the second feature line within the matched segment. Additionally, the prevention may allow for detection of the lane markings associated with the set of lane segments around the turning location. The turning location may correspond to a decision point that allows users of the set of vehicles to determine whether to steer off or continue navigation on the road segment. In an embodiment, the turning location may be indicative of a driving behavior of the users of the set of vehicles that may be associated with a driving efficiency, a driving safety and a driving automation. In an embodiment, the driving behavior may be determined from an overlay of multiple-sensor detection (such as the feature line data 106). In an embodiment, the turning location may be determined based on the connectivity of the first feature line and the second feature line. In an embodiment, the turning location may be referred to as junction location.

In operation, the system 102 is configured to obtain the feature line data 106 of each of the plurality of feature lines associated with the geographical region. In an embodiment, the system 102 may obtain the feature line data 106 for mapping of a road segment associated with the geographical region from one or more sources, such as a database associated with the system 102, a map database, a third-party database, etc.

The system 102 is configured to select the pair of adjacent feature lines from the plurality of feature lines based on the feature line data 106. Further, the pair of adjacent feature lines may include the first feature line and the second feature line. In an embodiment, the first feature line may be indicative of the first lane marking associated with the geographical region. In another embodiment, the second feature line may be indicative of the second lane marking associated with the geographical region. Further, the first lane marking and the second lane marking may be associated with the set of lane segments.

Further, the system 102 is configured to determine the matched segment data associated with the matched segment between the first feature line and the second feature line. In an embodiment, the part of the first feature line and the part of the second feature line may correspond to the matched segment. In an embodiment, the matched segment data may include, but are not limited to, a length of the matched segment between the first feature line and the second feature line, a location associated with a part of the first feature line corresponding to the matched segment, and a location associated with a part of the second feature line corresponding to the matched segment. Further, a distance between the first feature line and the second feature line within the matched segment is less than the threshold (such as 2 meters, 4 meters, 5 meters, or 10 meters). The system 102 may be configured to determine the distance between the first feature line and the second feature line based on the obtained feature line data 106. Based on the distance, the system 102 may identify a presence of the matched segment between the first feature line and the second feature line.

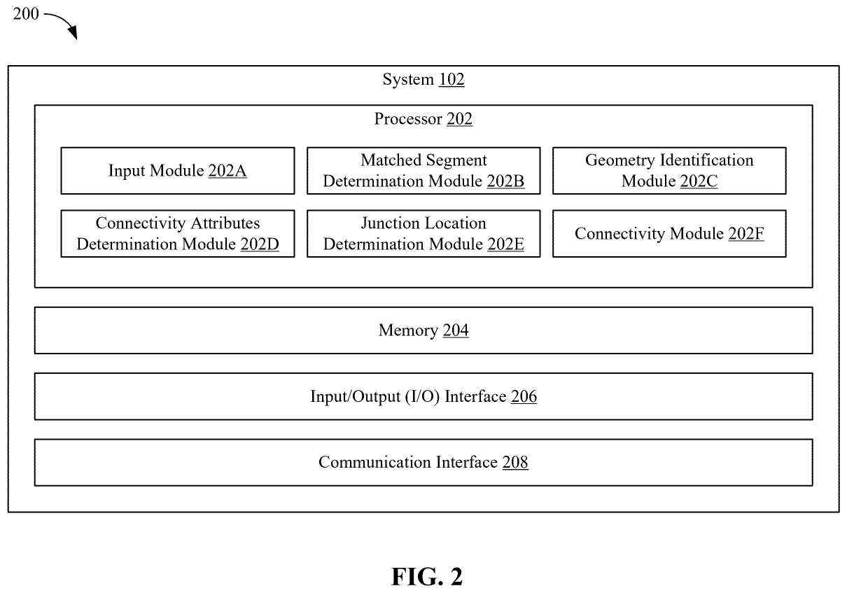

Further, the system 102 is configured to determine a set of connectivity attributes associated with the pair of adjacent feature lines based on the matched segment data. The set of connectivity attributes may include, but is not limited to, a heading feature associated with the first geometry and the second geometry, a length feature of the matched segment, a first distance feature associated with the first geometry and the second geometry, a second distance feature associated with the matched segment and a start location of the second geometry, a third distance feature associated with the matched segment and an end location of the second geometry, a fourth distance feature associated with the matched segment and an end location of the first geometry, a fifth distance feature associated with the matched segment and an end location of the first geometry, and an intersection feature associated with the intersection of the first geometry and the second geometry. Details about the set of connectivity attributes are provided, for example, in FIG. 2.

The system 102 is configured to determine a junction location associated with the first feature line and the second feature line based on the matched segment data. The junction location may correspond to the decision point that allows users of the set of vehicles to determine whether to steer off or continue navigation in the geographical region. In an embodiment, the junction location may be indicative of the driving behavior of the users of the set of vehicles that may be associated with the driving efficiency, the driving safety and the driving automation.

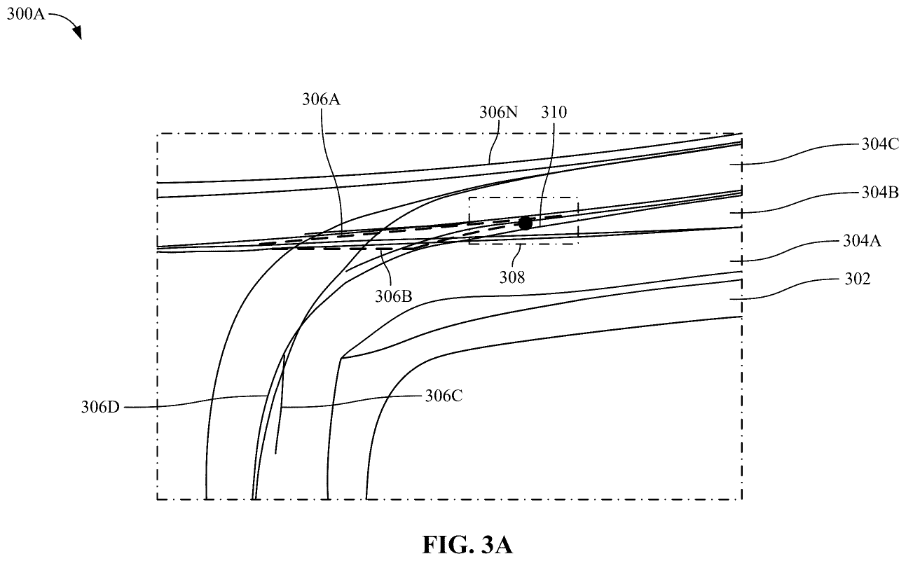

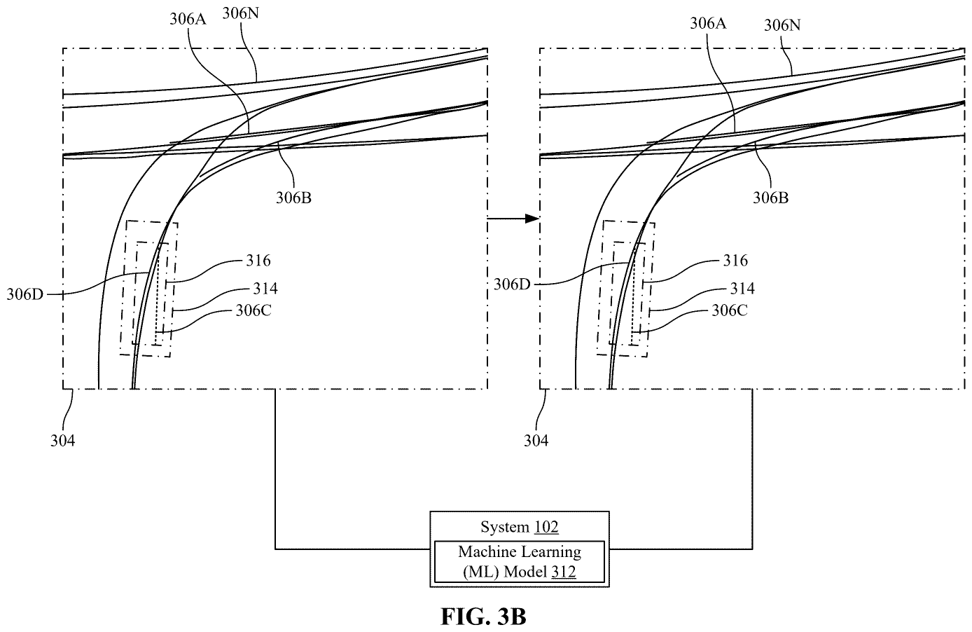

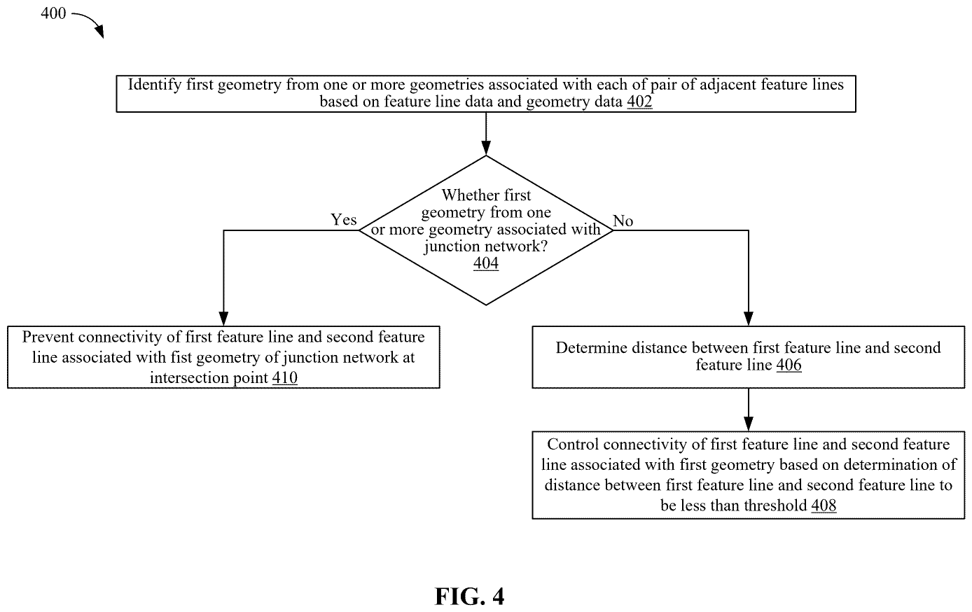

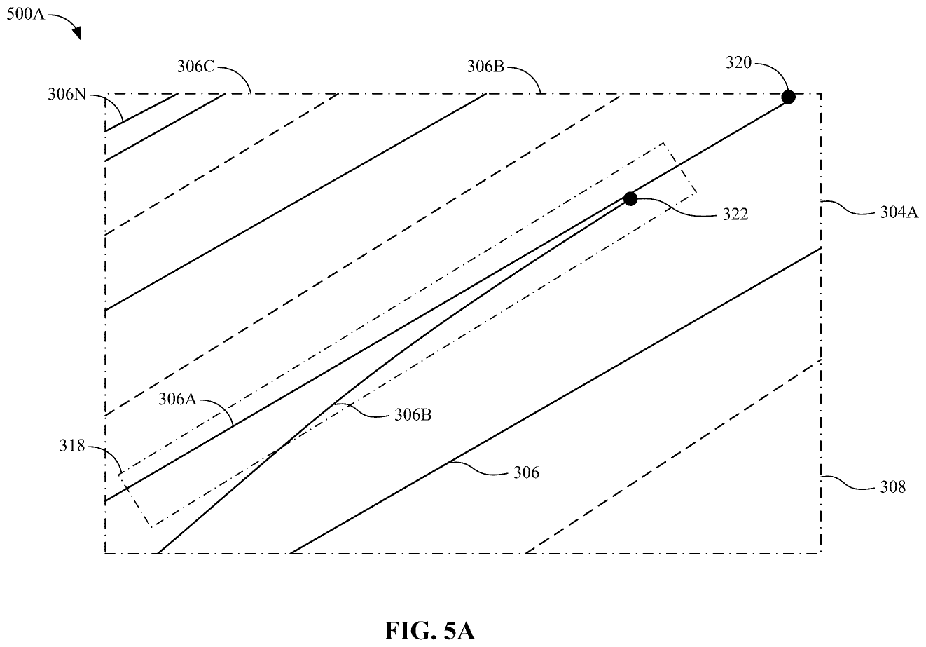

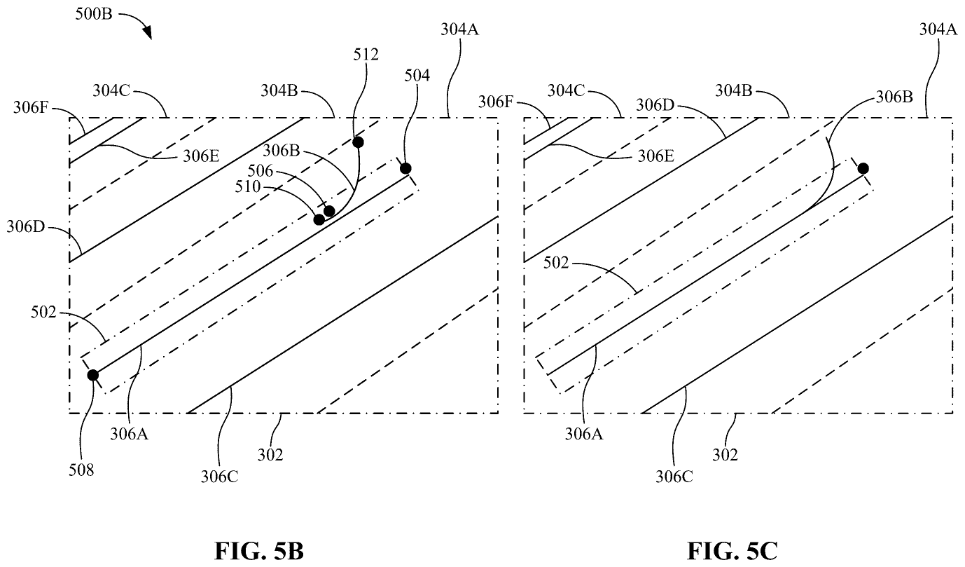

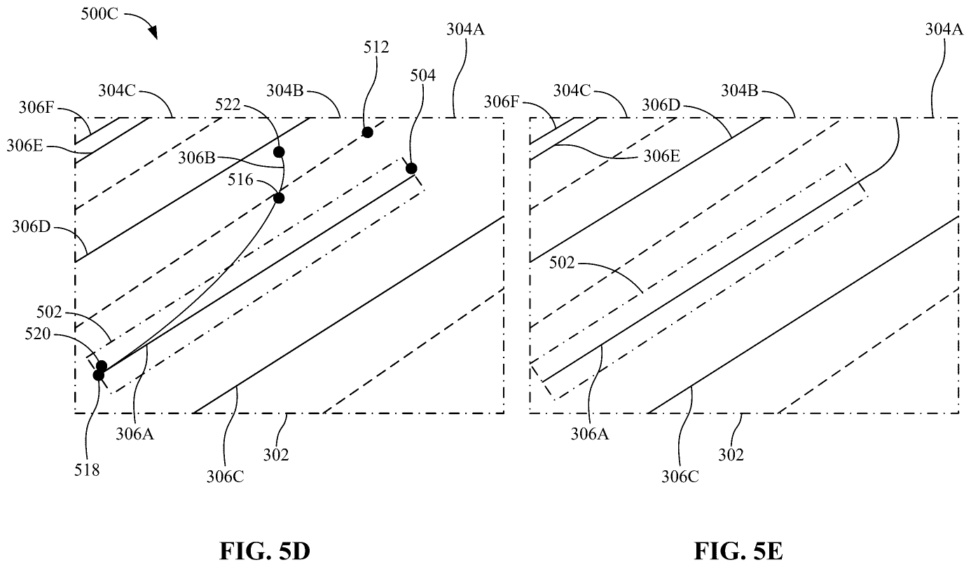

The system 102 is configured to control a connectivity of the first feature line and the second feature line within the matched segment based on the set of connectivity attributes and the junction location. In an embodiment, to control the connectivity, the system 102 may be configured to update a part of the first feature line and/or the second feature line based on the set of connectivity attributes and the junction location. This part may correspond to the matched segment between the first feature line and the second feature line. In an embodiment, the system 102 may be configured to control the connectivity of the first feature line and the second feature line based on a determination that a distance between the first feature line and the second feature line is less than the threshold. The controlling of the connectivity of the first feature line and the second feature line may allow for a mitigation of challenges associated with the connectivity of the first feature line and the second feature line around the junction location. Specifically, the controlling of the connectivity of the first feature line and the second feature line. Details about the controlling of the connectivity of the plurality of features lines are provided, for example, in conjunction with FIG. 3A, FIG. 3B, FIG. 3C, FIG. 4A, FIG. 4B, FIG. 5A and FIG. 5B.

In an embodiment, the system 102 may be communicatively coupled to the mapping platform 104, via the network 108. In an embodiment, the system 102 may be communicatively coupled to other components not shown in FIG. 1 via the network 108. All the components in the network environment 100 may be coupled directly or indirectly to the network 108. The components described in the network environment 100 may be further broken down into more than one component and/or combined together in any suitable arrangement. Further, one or more components may be rearranged, changed, added, and/or removed.

FIG. 2 illustrates a block diagram 200 of the system 102 of FIG. 1, in accordance with an embodiment of the disclosure. FIG. 2 is explained in conjunction with FIG. 1. The system 102 may include at least one processor 202 (referred to as a processor 202, hereinafter), at least one non-transitory memory 204 (referred to as a memory 204, hereinafter), an input/output (I/O) interface 206, and a communication interface 208. The processor 202 may include modules, depicted as, an input module 202A, a matched segment determination module 202B, a geometry identification module 202C, a connectivity attributes determination module 202D, a junction location determination module 202E, and a connectivity module 202F. The system 102 may be connected to the memory 204, and the I/O interface 206 through wired or wireless connections. Although in FIG. 2, it is shown that the system 102 includes the processor 202, the memory 204, and the I/O interface 206 however, the disclosure may not be so limiting and the system 102 may include fewer or more components to perform the same or other functions of the system 102. In an embodiment, the input module 202A, and the connectivity module 202E may be integrated within the I/O interface 206. In some embodiments, the input module 202A may receive input data, such as the feature line data 106, and the connectivity module 202E may output processed data, such as at least one updated feature line of the plurality of feature lines via the I/O interface 206.

The processor 202 of the system 102 may be configured to control the connectivity of the first feature line and the second feature line within the matched segment. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

The input module 202A of the processor 202 may be configured to obtain the feature line data 106, which may be collected from, for example, a set of vehicles or a database associated with the set of vehicles. In an embodiment, the set of vehicles may have previously travelled in the geographical region. The feature line data 106 may be indicative of each of the plurality of feature lines for the set of vehicles. Each feature line of the plurality of feature lines may include a plurality of location points associated with a respective lane marking associated with the geographical region. In an embodiment, the feature line data 106 may include, but is not limited to, latitude information (such as a latitude coordinate) associated with each location point of the plurality of location points, longitude information (such as a longitude coordinate) associated with each location point of the plurality of location points, temporal information (such as timestamps) associated with each location point of the plurality of location points, navigation information (such as a speed) associated with each vehicle of the set of vehicles at each location point of the plurality of location points.

In an embodiment, the system 102 may be configured to select the pair of the adjacent feature lines from the plurality of feature lines based on the feature line data 106. Specifically, the processor 202 may be configured to select the pair of the adjacent feature lines from the plurality of feature lines based on the feature line data 106. Further, the pair of adjacent feature lines may include the first feature line and the second feature line. In an embodiment, the first feature line may be indicative of a first lane marking associated with a first lane segment of the set of lane segments. In another embodiment, the second feature line may be indicative of a second lane segments associated with a second lane segment of the set of lane segments. Further, the first lane segment and the second lane segment may be associated with the road segment in the geographical region.

In an embodiment, the system 102 may be configured to determine geometry data based on the feature line data 106. The geometry data may be associated with each of one or more geometries within the geographical region. Further, one or more geometries may be indicative of a shape of the road segment, a size of the road segment, a width of the road segment, and a location of the road segment.

The geometry data may include, but is not limited to, lateral offset data associated with each of the one or more geometries, orientation data associated with each of the one or more geometries, or elevation data associated with each of the one or more geometries. In an embodiment, the lateral offset data for a feature line may be indicative of a perpendicular distance from each of the plurality of location points to a first reference point associated with the geographical region. Additionally, each of the plurality of feature lines may include the plurality of location points. In an embodiment, the first reference point may correspond to an intersection point associated with the road segment. In another embodiment, the first reference point may correspond to a centre of the road segment or at least one edge associated with the road segment. In an embodiment, the orientation data may be indicative of a direction of each lane marking with respect to a reference direction (such as a direction of the road segment, or a true north direction associated with a north pole of the Earth). In an embodiment, the orientation data may include a set of angles indicative of the direction of each lane marking with respect to the reference direction. In an example embodiment, a first angle of the set of angles may be indicative of a first direction of the first lane marking associated with the geographical region. In an embodiment, the elevation data may be indicative of an elevation of the geographical region for each of the plurality of the feature lines. The elevation may correspond to a height of the geographical region with respect to a sea level.

In an embodiment, the one or more geometries may be associated with, for example, an intersection geometry, a turning geometry, a splitting geometry, a connectivity geometry, or a straight geometry. In an embodiment, the intersection geometry may be indicative of an intersection of at least two-lane marking (such as the first lane marking and the second lane marking) at the junction location. Additionally or alternatively, the intersection geometry may be indicative of an intersection of a traffic flow at the junction location. The traffic flow may correspond to a direction of a movement of the set of vehicles on the first lane segment and the second lane segment. In an embodiment, the turning geometry may be indicative of a turning of the second lane marking towards the location of the first lane marking. Additionally, or alternatively, the turning geometry may be indicative of turning of the traffic flow towards the location of the second lane marking. In an embodiment, the splitting geometry may be indicative of a splitting of the first lane marking and the second lane marking at the junction location at the junction location. Additionally or alternatively, the splitting geometry may be indicative of the splitting of the traffic flow at the junction location. In an embodiment, the connectivity geometry may be indicative of a connectivity of the first lane marking and the second lane marking at the junction location. In an embodiment, the straight geometry may indicate that the first lane marking is parallel with respect to the first reference point (such as the edge of the road segment). Additionally or alternatively, the straight geometry may indicate that the traffic flow is parallel with respect to the first reference point.

The matched segment determination module 202B of the processor 202 may be configured to determine the matched segment data. The matched segment data may be associated with the matched segment between the first feature line and the second feature line. In an embodiment, the matched segment data may include, but are not limited to, the length of the matched segment between the first feature line and the second feature line, the location associated with the part of the first feature line corresponding to the matched segment, and the location associated with the part of the second feature line corresponding to the matched segment. Further, the distance between the first feature line and the second feature line within the matched segment is less than the threshold. In an embodiment, based on a determination that the distance between the part of the first feature line and the second feature line is less than the threshold, the system 102 may be configured to identify the part of the first feature line and the second feature line as the matched segment. In an embodiment, the matched segment may include the intersection point associated with the intersection of the first feature line and the second feature line.

In an embodiment, the geometry identification module 202C of the processor 202 may be configured to identify a geometry from the one or more geometries based on the feature line data 106 and the geometry data. The geometry may be associated with each pair of the pair of adjacent features lines. In an embodiment, the pair of the adjacent feature lines may include the first feature line and the second feature line. In an embodiment, the first feature line may be associated with a first geometry and a second geometry of the one or more geometries, respectively. In an embodiment, the first geometry may correspond to the straight geometry. Further, the second geometry may correspond to the intersection geometry, the turning geometry, the splitting geometry, or the connectivity geometry.

The connectivity attributes determination module 202D of the processor 202 may be configured to determine the set of connectivity attributes associated with the pair of adjacent feature lines based on the matched segment data. The set of connectivity attributes may include, but is not limited to, a heading feature associated with the first geometry and the second geometry, a first distance feature associated with the first geometry and the second geometry, a second distance feature associated with the matched segment and a start location of the second geometry, a third distance feature associated with the matched segment and an end location of the second geometry, a fourth distance feature associated with the matched segment and an end location of the first geometry, a fifth distance feature associated with the matched segment and an end location of the first geometry, and an intersection feature associated with the intersection of the first geometry and the second geometry.

In an embodiment, the heading feature may be indicative of a difference between a heading of the first geometry and a heading of the second geometry. In an embodiment, the first distance feature may be associated with the distance between the first geometry and the second geometry. In an embodiment, the second distance feature may be indicative of a distance between the matched segment and the start location of the second geometry. In an embodiment, the third distance feature may be associated with the matched segment and the end location of the second geometry. In an embodiment, the fourth distance feature may be associated with the matched segment and the end location of the first geometry. In an embodiment, the fifth distance feature may be indicative of a distance between the matched segment and the end location of the first geometry. In an embodiment, the intersection feature may be indicative the intersection of the first geometry and the second geometry.

The junction location determination module 202E of the processor 202 may be configured to determine the junction location associated with the first feature line and the second feature line based on the matched segment data. In an embodiment, the junction location may correspond to an intersection point associated with the first geometry and the second geometry. The connectivity module 202F of the processor 202 may be configured to control the connectivity of the first feature line and the second feature line within the matched segment based on the set of connectivity attributes and the junction location. Details about the connectivity of the first feature line and the second feature line are provided, for example, in FIG. 3A, FIG. 3B, FIG. 3C, FIG. 4A, FIG. 4B, FIG. 5A, and FIG. 5B.

The memory 204 of the system 102 may be configured to store the feature line data 106. The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

In some example embodiments, the I/O interface 206 may communicate with the system 102 and display the input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry comprising the processor 202 may be configured to control one or more functions of one or more I/O interface 206 elements through computer program instructions (for example, software and/or firmware) stored on a memory 204 accessible to the processor 202.

The communication interface 208 may include an input interface and output interface for supporting communications to and from the system 102 or any other component with which the system 102 may communicate. The communication interface 208 may be any means such as a device or circuitry embodied in either hardware or a combination of hardware and software that is configured to receive and/or transmit data to/from a communications device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms. In some embodiments, the communication interface 208 may enable communication with a cloud-based network to enable deep learning, such as using a set of machine learning (ML) models (that may be hosted on the cloud-based network).

In an embodiment, the system 102 may be configured to control the connectivity of the first feature line and the second feature line based on an association of the one or more geometries with the junction network. Accordingly, a diagram is provided with reference to FIG. 3A.

FIG. 3A is a diagram that illustrates a first exemplary environment 300A for controlling connectivity of the feature lines within the junction networks is implemented, in accordance with an embodiment of the disclosure. With reference to FIG. 3A, the first exemplary environment 300A may include a geographical region 302. The geographical region 302 may include a plurality of lane segments 304A, 304B, and 304C (hereinafter also referred to as lane segments 304A-304C). The plurality of lane segments 304A-304C may be associated with a plurality of feature lines 306A, 306B, 306C, 306D, up to 306N (hereinafter also referred to as plurality of feature lines 306A-06N). In an embodiment, the feature line 306A, the feature line 306B, the feature line 306C, the feature line 306D, the feature line 306N may be referred to as first feature line 306A, second feature line 306B, the third feature line 306C, the fourth feature line 306D, and the Nth feature line, respectively. In an embodiment, the system 102 may be configured to determine geometry data associated with each of the one or more geometries within the geographical region 304 based on the feature line data 106. Details about the geometry data are provided, for example, in FIG. 2.

Based on the feature line data 106 and the geometry data, the system 102 may be configured to identify a geometry from the one or more geometries associated with each of the pair of adjacent feature lines (such as the first feature line 306A and the second feature line 306B). The system 102 may be configured to identify at least one nearby geometry for each of the one or more geometries based on the geometry data. The at least one nearby geometry may be selected from the one or more geometries.

Further, the system 102 may be configured to determine a set of geometry parameters for each of the one or more geometries based on the corresponding at least one nearby geometry. The set of geometry parameters may include, but is not limited to, a geometry length parameter, a geometry orientation parameter, a geometry distance parameter, a geometry location parameter. In an embodiment, the geometry length parameter may be indicative of a length (such as 2 meters, 5 meters, 8 meters, or 10 meters) of each of the one or more geometries. In an embodiment, a geometry orientation parameter may be indicative of a difference of an orientation of the nearby geometry and an orientation of each of the one or more geometries. In an embodiment, geometry distance parameter may be indicative of a distance between an end location of the nearby geometry from a body of each of the one or more geometries. Additionally the geometry distance parameter may be indicative of a distance between a start location of the nearby geometry from the body of each of the one or more geometries. In an embodiment, the geometry location parameter may be indicative of a location of the nearby geometry corresponding to each of the one or more geometries. The system 102 may be further configured to determine whether each of the one or more geometries is associated with a junction network 308 or not, based on the corresponding set of geometry parameters. In an embodiment, the system 102 may be configured to control the connectivity of the first feature line 306A and the second feature line 306B based on the corresponding geometry and the determination.

In an embodiment, the first feature line 306A may be associated with the first geometry from the one or more geometries. In an embodiment, the first geometry may be referred to as the target geometry. In an embodiment, the first geometry may correspond to the straight geometry. The straight geometry may indicate that the first feature line 306A is parallel to the first reference point (such as an edge of the lane segment 304A). Additionally, the second feature line 306B may be associated with the second geometry. In an embodiment, the second geometry may correspond to the connectivity geometry. The connectivity geometry may indicate that the second feature line 306B may connect with the first feature line 306A at an intersection point 310.

In an embodiment, the system 102 may be configured to compare a length of the first geometry with a first length based on the geometry length parameter. In an embodiment, the system 102 may be configured to determine that the first geometry is associated with the junction network 308 based on a determination that the length of the first geometry is less than the first length. Further, the system 102 may be configured to prevent the connectivity of the first feature line 306A and the second feature line 306B based on the determination that the first feature line 306A is associated with the junction network 308 at the intersection point 310.

In another embodiment, the system 102 may be configured to determine a difference between an orientation of the first geometry and the orientation of the nearby geometry (such as a second geometry associated with the feature line 306B) based on the geometry orientation parameter. In an embodiment, the system 102 may be configured to determine that the first geometry is associated with the junction network 308 based on a determination that orientation difference is greater than an orientation threshold. In an embodiment, the system 102 may be configured to prevent the connectivity of the first feature line 306A and the second feature line 306B based on a determination that the first feature line 306A is associated with the junction network 308 at the intersection point 310.

In yet another embodiment, the system 102 may be configured to determine a first distance between an end location of the first geometry and a body location of the second geometry based on the geometry distance parameter. The body location of the second geometry may correspond to the closest point of the second geometry from the end location of the first geometry. Further the system 102 may be configured to determine a second distance between a start location of the first geometry and the body location of the second geometry. In an embodiment, the system 102 may be configured to compare the first distance and the second distance with a first distance threshold and the second distance threshold, respectively. In an embodiment, the system 102 may be configured to determine that the first geometry is associated with the junction network 308 based on a determination that first distance and the second distance is less than the first distance threshold and the second distance threshold, respectively. In an embodiment, the system 102 may be configured to prevent the connectivity of the first feature line 306A and the second feature line 306B based on a determination that the first feature line 306A is associated with the junction network 308 at the intersection point 310.

In an additional embodiment, the system 102 may be configured to determine a third distance between a first location associated with the first geometry and a second location associated with the second geometry based on the geometry location parameter. Further, the system 102 may be configured to compare the third distance with a third distance threshold. In an embodiment, the system 102 may be configured to determine that the first geometry is associated with the junction network 308 based on a determination that the third distance is less than the third distance threshold. In an embodiment, the system 102 may be configured to prevent the connectivity of the feature line 306A and the feature line 306B at the at least one intersection point (such as the intersection point 310) based on a determination that the first geometry is associated with the junction network 308.

In an embodiment, the system 102 may be configured to control the connectivity of the plurality of feature line 306A-306N based on an application of a machine learning model (ML). Accordingly, a diagram is provided with reference to FIG. 3B.

FIG. 3B is a diagram that illustrates an implementation of a ML model 312 for controlling connectivity of the feature lines within the junction networks, in accordance with an embodiment of the disclosure. With reference to FIG. 3B, the system 102 of FIG. 1 may include the ML model 312. Further, with reference to FIG. 3B, the feature line 306C may be associated with the first geometry from the one or more geometries and the feature line 306D may be associated with the second geometry from the one or more geometries.

In an embodiment, the system 102 may be configured to determine the first geometry and the second geometry to be associated with the junction network 314 based on the set of geometry parameters associated with the first geometry and a set of geometry parameters associated with the second geometry. In an embodiment, the first geometry may correspond to the intersection geometry. The intersection geometry may be indicative of an intersection of the feature line 306C and the feature line 306D. Further, the second geometry may correspond to the turning geometry. The turning geometry may be indicative of a turning of the feature line 306D around a junction network 318. In an embodiment, the system 102 may be configured to determine a redundancy between the feature line 306C and the feature line 306D based on the first geometry associated with the feature line 306C and the second geometry associated with the feature line 306D. The redundancy may lead to challenges associated with a determination of a geometry of the geographical region 302 by connectivity of the feature line 306C and the feature line 306D.

In an embodiment, the system 102 may be configured to determine, using the ML model 312, a connectivity condition for controlling the connectivity of a matched segment 316 between the feature line 306C and the feature line 306D based on the set of connectivity attributes. Details about the set of connectivity attributes are provided, for example, in FIG. 2.

In an embodiment, the system 102 may be configured to apply the ML model 312 to determine the connectivity condition for controlling the connectivity of the matched segment 316. In an embodiment, the ML model 312 may be trained to identify a relationship between the set of inputs (such as the set of connectivity attributes) in a training dataset, and output the connectivity condition. The ML model 312 may be defined by its hyper-parameters, for example, a number of weights, cost function, input size, number of layers, and the like. The hyper-parameters of the ML model 312 may be tuned and weights may be updated to move towards a global minima of a cost function for the corresponding ML model. After several epochs of the training on the feature information in the training dataset, the ML model 206 may be trained to output the connectivity condition for the set of inputs. The ML model 312 may include electronic data, such as, for example, a software program, code of the software program, libraries, applications, scripts, or other logic or instructions for execution by a processing device, such as the system 102. The ML model 312 may include code and routines configured to enable a computing device, such as the system 102 to perform one or more operations associated with the controlling connectivity of the plurality of feature lines 302A-302N around the junction networks (such as the junction network 308 or the junction network 314). Additionally, or alternatively, the ML model 312 may be implemented using hardware including a processor, a microprocessor (e.g., to perform or control the performance of one or more operations), a field-programmable gate array (FPGA), or an application-specific integrated circuit (ASIC). Alternatively, in some embodiments, the ML model 312 may be implemented using a combination of hardware and software. Examples of the ML model 206 may include, but are not limited to, a Deep Neural Network (DNN), an Artificial Neural Network (ANN), a Convolutional Neural Network (CNN), or combination thereof.

In an embodiment, the system 102 may be further configured to connect the feature line 306C and the feature line 306D within the matched segment 316 based on the connectivity condition. In an example, the connectivity condition may classify a manner in which the feature line 306C and the feature line 306D should be connected or disconnected within the matched segment 316. In an embodiment, the connectivity condition may correspond to a first connectivity condition or a second connectivity condition. The first connectivity condition may be associated with removing a part of the feature line 306C within the matched segment 316 or removing a part of the feature line 306D within the matched segment 316. This may prevent inaccurate connection of the feature line 306C and the feature line 306D. Further, the truncation of the part may prevent challenges associated with the redundancy of the feature line 306C and the feature line 306D The second connectivity condition may be associated with combining the part of the feature line 306C within the matched segment 316 with the part of the feature line 306D within the matched segment 316. In this regard, the part of the feature line 306C and the part of the feature line 306D may be extended to connect the two feature lines. The connectivity of the feature lines 306C and 306D based on the first connectivity condition or the second connectivity condition may ensure that the connection is smoot and accurate, thereby enhancing map data associated with the junction network.

FIG. 4 illustrates a flowchart for implementation of an exemplary method 400 for controlling connectivity of the feature lines within the junction networks, in accordance with an embodiment of the disclosure. In various embodiments, the mapping platform 104 or the system 102 may perform one or more portions of the exemplary method 400 and may be implemented in, for instance, a chip set including a processor and a memory. As such, the mapping platform 104 or the system 102 may provide means for accomplishing various parts of the exemplary method 400, as well as means for accomplishing embodiments of other processes described herein in conjunction with other components of the system 102. Although the exemplary method 400 is illustrated and described as a sequence of steps, it may be contemplated that various embodiments of the exemplary method 400 may be performed in any order or combination and need not include all of the illustrated steps.

At 402, the first geometry may be identified from the one or more geometries based on the feature line data 106 and the geometry data. The one or more geometries are associated with each pair of the adjacent feature lines (such as the feature line 306A and the feature line 306B, or the feature line 306C or the feature line 306D). In an embodiment, the system 102 may be configured to identify the first geometry from the one or more geometries based on feature line data 106 and the geometry data. The one or more geometries may be associated with each of pair of adjacent feature lines. In an embodiment, details about the identification of the first geometry are provided, for example, in FIG. 3A and FIG. 3B.

At 404, a determination is made whether the first geometry from the one or more geometry associated with the junction network 314. In an embodiment, based on the set of geometry parameters associated with the junction network 314, the system 102 may be configured to determine whether the first geometry is associated with the one or more geometries or not. If the first geometry from the one or more geometries is not associated with the junction network 314, the method 400 may continue at 406 based on the feature line 306C and the feature line 306D. Otherwise, the method 400 may continue at 410 for controlling connectivity of the feature line 306C and the feature line 306D.

At 406, the distance between the first feature line (such as the feature line 306C) and the second feature line (such as the feature line 306D) may be determined. In an embodiment, the system 102 may be configured to determine the distance between the feature line 306C and the feature line 306D based on the feature line data 106. In another embodiment, the processor 202 may be configured to determine the distance between the feature line 606C and the feature line 606D. Details about the feature line data 106 are provided, for example, in FIG. 2.

At 408, the connectivity of the feature line 306C and the feature line 306D may be controlled based on a determination of the distance between the feature line 306C and the feature line 306D to be less than the threshold. In an embodiment, the system 102 may be configured to control the connectivity of the feature line 306C and the feature line 306D based on the connectivity condition. In an embodiment, the system 102 may be configured to determine, using the ML model 312, the connectivity condition for controlling the connectivity of the feature line 306C and the feature line 306D within the matched segment 316 based on the connectivity condition. Details about the connectivity condition are provided, for example, in FIG. 3B.

At 410, the connectivity of the feature line 306C and the feature line 306C may be prevented at the at least one intersection point based on a determination that the first geometry is not associated with the junction network 314. In an embodiment, the system 102 may be configured to prevent the connectivity of the feature line 606C and the feature line 606C at the at least one intersection point. Details about the prevention of the first feature line and the second feature line are provided, for example, in FIG. 3A, and 3B.

In an embodiment, the system 102 may be configured to determine the junction location associated with the first feature line 306A and the feature line 306B based on the identification of the one or more geometries associated with the plurality of feature lines 306A-306N. Accordingly a diagram is provided with reference to FIG. 5A.

FIG. 5A is a diagram that illustrates a second exemplary environment 500A for controlling connectivity of the feature lines within the junction networks, in accordance with an embodiment of the disclosure. With reference to FIG. 5A, the second exemplary environment 500A may include the set of lane segments 304A-304C, the plurality of feature lines 306A-306F, and the junction network 308 of FIG. 3A.

In an embodiment, each feature line of the plurality of feature lines 306A-306N may be indicative of a lane marking associated with the set of lane segments 304A-304C. In an embodiment, the system 102 may be configured to obtain feature line data 106 of each of the plurality of feature lines 306A-306N associated with the geographical region 302. The system 102 may be further configured to select the pair of adjacent feature lines (such as the first feature line 306A and the second feature line 306B) from the plurality of feature lines 306A-306N based on the feature line data 106. The system 102 may be further configured to determine matched segment data associated with a matched segment 318 between the first feature line 306A and the second feature line 306B. Further, a distance between the first feature line 306A and the second feature line 306B within the matched segment 306B is less than the threshold (such as 10 meters). Details about the matched segment data are provided, for example, FIG. 1 and FIG. 2.

In an embodiment, the system may be configured to identify the geometry from the one or more geometries associated with each of the adjacent feature lines (such as the first feature line 306A and the feature line 306B) based on the feature line data 106 and the geometry data. Details about the feature line data 106 and the geometry data are provided, for example, in FIG. 1 and FIG. 2. In another embodiment, the system 102 may be configured to obtain the map data associated with the first geographical region 302. In an embodiment, the system 102 may be configured to obtain the map data from the mapping database 104B. Further, the system 102 may be configured to segment each of the plurality of feature lines 306A-306N into one or more portions based on the feature line data 106. In an example embodiment, the one or more portions may correspond to a part of at least one of the first feature line 306A or the second feature 306B within the matched segment 318. Further, the system 102 may be configured to identify the one or more geometries within the first geographical region 302 based on the map data, the feature line data 106 and the segmentation. The system 102 may be further configured to associate each of the one or more portions of each of the plurality of feature lines 306A-306N with the one of the one or more geometries.

In an embodiment, the first feature line 306A may be associated with the first geometry. In an embodiment, the first geometry may correspond to the straight geometry that may indicate that the first feature line 306A is a straight feature line with respect to the first reference point (such as an edge of the lane segment 304A). Further, the second feature line 306B may be associated with the second geometry. In an embodiment, the second geometry may correspond to a turning geometry. The turning geometry may be indicative of a turning of the second feature line 306A corresponding to the first feature line 306A. The system 102 may be further configured to determine the set of connectivity attributes associated with the pair of adjacent feature lines (such as the first feature line 306A and the second feature line 306B) based on the matched segment data. Details about the set of connectivity attributes are provided, for example, in FIG. 2.

The system 102 may be further configured to identify an end location 320 associated with the first feature line 306A. Further, the system 102 may be configured to a distance between the end location 320 of the first feature line 306A and a body location 322 of the second feature line 306B. The body location 332 may correspond to a closest point of the second feature line 306A from the end location 320 of the first feature line 306A.

The system 102 may be further configured to determine the junction location based on the distance, the end location 320 of the first feature line 306A and the body location 322 of the second feature line 306B. In an embodiment, the junction location may be referred to as turning location associated with the geographical region 302. The junction location may correspond to the decision point that allows users of the set of vehicles to determine whether to steer off or continue navigation on the set of lane segments 304A-304N. In an embodiment, the junction location may be indicative of the driving behavior of the users of the set of vehicles that may be associated with the driving efficiency, the driving safety and the driving automation.

In an embodiment, the system 102 may be configured to control the connectivity of the first feature line 306A and the second feature line 306B within the matched segment 318 based on the set of connectivity attributes and the junction location. In an embodiment, the system 102 may be configured to prevent the connectivity of the first feature line 306A and the second feature line 306B based on the set of connectivity attributes and the junction location. In an embodiment, the system 102 may be configured to prevent the connectivity of the first feature lien 306A and the second feature line 306B corresponding to the length of the matched segment 318. The prevention of the connectivity of the first feature line 306A and the second feature line 306B may allow to mitigate the challenges associated with the generation of right-skewed segments by the connectivity of the first feature line 306A and the second feature line 306A. In an embodiment, the right-skewed segments may correspond to distorted segments generated based on the connectivity of the first feature line 306A and the second feature line 306B.

In an embodiment, to control the connectivity of the first feature line 306A and the second feature 306B, the system 102 may be configured to update the part of the at least one of the first feature line 306A and the second feature line 306B based on the set of connectivity attributes and the junction location. The part corresponds to the matched segment 318. Accordingly, diagrams are provided, for example, in FIG. 5B and FIG. 5C.

FIG. 5B and FIG. 5C are diagrams that illustrates a third exemplary environment for controlling connectivity of the feature lines within the junction networks, in accordance with an embodiment of the disclosure. With reference to FIG. 5B, and the FIG. 5C, the first feature line 306A may be associated with the first geometry and the second feature line may be associated with the second geometry. The second geometry may correspond to the splitting geometry. The splitting geometry may be indicative of a splitting of the second feature line 306B from the first feature line 306A. In an embodiment, the first geometry and the second geometry may be referred to as existing geometry and the new geometry, respectively. In an embodiment, the system 102 may be further configured to determine the set of connectivity attributes associated with the pair of adjacent feature lines (such as the first feature line 306A and the second feature line 306B) based on the matched segment data. The matched segment data may be associated with a matched segment 502 between the first feature line 306A and the second feature line 306B.

The system 102 may be further configured to identify an end location 504 associated with the first feature line 306A. Further, the system 102 may be configured to a distance between the end location 504 of the first feature line 306A and a body location 506 of the second feature line 306B. The body location 506 may correspond to the closest point of the second feature line 306A from the end location 504 of the first feature line 306A. Additionally, the system 102 may be configured to determine a start point 508 associated with the first feature line 306A based on at least the feature line data 106. The system 102 may be further configured to determine a start point 510 and an end point 512 associated with the second feature line 306B.

The system 102 may be further configured to determine the junction location based on the distance, the end location 504 of the first feature line 306A and the body location 506 of the second feature line 306B. In an embodiment, the system 102 may be configured to control a connectivity of the first feature line 306A and the second feature line 306B within the matched segment 502 based on the set of connectivity attributes and the junction location. Further, the system 102 may be configured to updating the part of at least one of the first feature line 306A, or the second feature line 306B based on the set of connectivity attributes and the junction location. The part may correspond to the matched segment 502. Referring to FIG. 3B, the system 102 may be configured to remove the part of the second feature line 306B within the matched segment 502. Further, the system 102 may be configured to combine the part of the first feature line 306A within the matched segment 502 with the part of the second feature line 306B within the matched segment 502. In an embodiment, the system 102 may be configured to remove the part of the second feature line 306B based on at least one of (i) a determination that a distance between the matched segment 502 and the start point 510 is less than a distance threshold (such as 2 meters, 4 meters, or 6 meters), (ii) a determination that a distance between the matched segment 502 and the end point 512 is not less than the distance threshold, (iii) a determination that a distance between the matched segment 502 and the start point 508 is not less that the distance threshold, (iv) a determination that a distance between the matched segment 502 and the end location 504 is less than the threshold, (v) a determination that the second feature line 306B not intersects the first feature line 306A.

FIG. 5D and FIG. 5E are diagrams that illustrates the third exemplary environment for controlling connectivity of the feature lines within the junction networks, in accordance with an embodiment of the disclosure. With reference to FIG. 5D, and the FIG. 5E, the first feature line 306A may be associated with the first geometry and the second feature line may be associated with the second geometry. The second geometry may correspond to the splitting geometry. The splitting geometry may be indicative of a splitting of the second feature line 306B from the first feature line 306A around an end location 514 of the first feature line 306A. In an embodiment, the first geometry and the second geometry may be referred to as existing geometry and the new geometry, respectively. In an embodiment, the system 102 may be further configured to determine the set of connectivity attributes associated with the pair of adjacent feature lines (such as the first feature line 306A and the second feature line 306B) based on the matched segment data. The matched segment data may be associated with a matched segment 524 between the first feature line 306A and the second feature line 306B.

The system 102 may be further configured to identify an end location 514 associated with the first feature line 306A. Further, the system 102 may be configured to a distance between the end location 514 of the first feature line 306A and a body location 516 of the second feature line 306B. The body location 516 may correspond to the closest point of the second feature line 306A from the end location 514 of the first feature line 306A. Additionally, the system 102 may be configured to determine a start point 518 associated with the first feature line 306A based on at least the feature line data 106. The system 102 may be further configured to determine a start point 520 and an end point 522 associated with the second feature line 306B.

The system 102 may be further configured to determine the junction location based on the distance, the end location 514 of the first feature line 306A and the body location 516 of the second feature line 306B. In an embodiment, the system 102 may be configured to control a connectivity of the first feature line 306A and the second feature line 306B within the matched segment 524 based on the set of connectivity attributes and the junction location. Further, the system 102 may be configured to update the part of at least one of the first feature line 306A, or the second feature line 306B based on the set of connectivity attributes and the junction location. The part may correspond to the matched segment 524. Referring to FIG. 3B and FIG. 3C, the system 102 may be configured to remove the part of the second feature line 306B within the matched segment 524. Further, the system 102 may be configured to combine the part of the first feature line 306A within the matched segment 524 with the part of the second feature line 306B within the matched segment 524. In an embodiment, the system 102 may be configured to remove the part of the second feature line 306B based on at least one of (i) a determination that a distance between the matched segment 524 and the start point 520 is less than the distance threshold (such as 2 meters, 4 meters, or 6 meters), (ii) a determination that a distance between the matched segment 524 and the end point 522 is not less than the distance threshold, (iii) a determination that a distance between the matched segment 524 and the start point 518 is less that the distance threshold, (iv) a determination that a distance between the matched segment 524 and the end location 514 is less than the threshold, (v) a determination that the second feature line 306B not intersects the first feature line 306A.

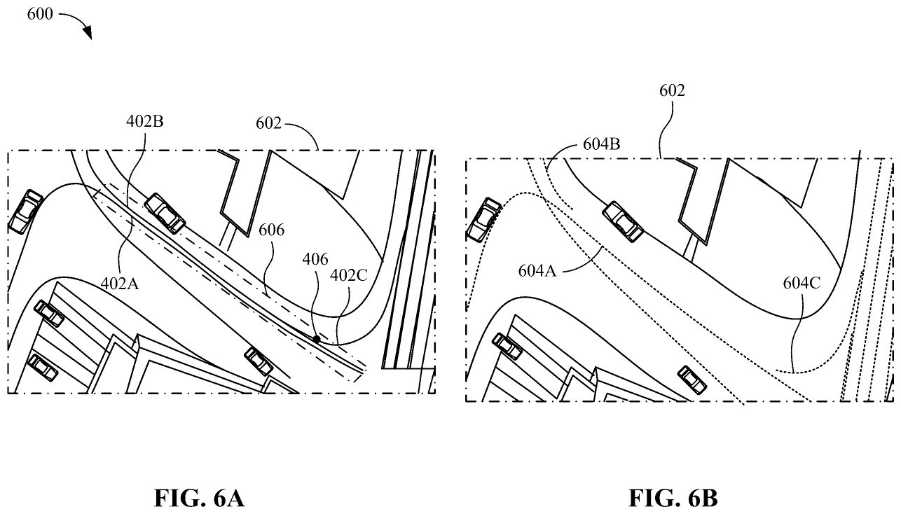

FIGS. 6A and 6B are diagrams that illustrates a fourth exemplary environment 600 for controlling connectivity of the feature lines within the junction networks, in accordance with an embodiment of the disclosure. With reference to FIG. 6A and FIG. 6B, the the fourth exemplary environment 600 may include a geographical region 602 that may include a plurality of feature lines 604A, 604B, and 604C (hereinafter also referred to as plurality of feature lines 604A-604C). In an embodiment, the plurality of feature lines 604A, 604B, and 604C may be referred to as a first feature line 604A, a second feature line 604B, and a third feature line 604C, respectively. Further, the first feature line 604A and the second feature line 604B may be associated with the connectivity geometry. The connectivity geometry may be indicative of a connectivity of the first feature line 604A and the second feature line 604B. Additionally, the first feature line 604A and the third feature line 604C may be associated with the connectivity geometry. The connectivity geometry may be indicative of a connectivity of the first feature line 604A and the third feature line 604C.

In an embodiment, the system 102 may be configured to update the part of at least one of the first feature line 604A, or the second feature line 604B based on the set of connectivity attributes and the junction location. Referring to FIG. 3B, the system 102 may be configured to remove the part of the second feature line 604A within a matched segment 606. The system 102 may be configured to prevent the connectivity of the first feature line 402A and the third feature line 402C at an intersection point 608.

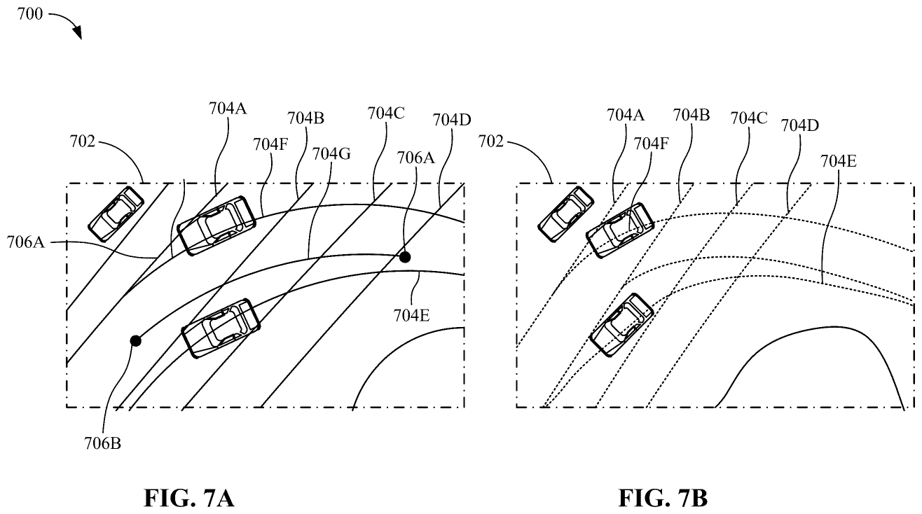

FIG. 7A and FIG. 7B are diagrams that illustrates a fifth exemplary environment 700 for controlling connectivity of the feature lines within the junction networks, in accordance with an embodiment of the disclosure. With reference to FIG. 7A and FIG. 7B, the fifth exemplary environment may include a geographical region 702 that may include a plurality of feature lines 704A, 704B, 704C, 704D, 704E, 704F, and 704G (hereinafter also referred to as plurality of feature lines 704A-704G). The feature line 704G may include an end point 706A and an end point 706B. Further, the system 102 may be configured to determine a gap between the end point 706A and a body of the feature line 704E. In an embodiment, the system 102 may be configured to determine the gap between the end point 706A of the feature line 704G and the body of the feature line 704E based on the junction location associated with the feature line 704G and the feature line 704E. In an embodiment, the system 102 may be configured to determine the junction location using the ML model 312. In an embodiment, the ML model 312 may employ a conflation re-arch algorithm to determine the junction location associated with the feature line 704G and the body of the feature line 704E.

In an embodiment, the system 102 may employ the conflation re-arch algorithm to formulate a ML problem to determine the connectivity of the feature line 704G with the feature line 704B, the feature line 704C, and the feature line 704D. In an embodiment, the system 102 may be configured to formulate, using the conflation re-arch algorithm, the ML problem based on the end point 706A of the feature line 704G and a set of end points associated with another geometries of the plurality of the feature lines 704A-704G. In an embodiment, the ML problem may correspond to at least one of a connectivity problem or a clustering problem. The clustering problem may indicate that the feature line 704G may include a point of sequence and a variant gap between two consecutive points (such as the end point 706A and the end point 706B). In an embodiment, to determine the gaps and orientations between two consecutive points, the system 102 may be configured to aggregate the gaps between the two consecutive points based on an application of a sampling technique. The clustering problem may further indicate that a converge angle of the feature line 704G is different from a converge angle of the feature line 704E. Further a part of the feature line 704G may be cluster with a part of the feature line 704E. However, there are challenges in a determination of an association of the feature line 704E and the feature line 704G with a same cluster. Hence, there is a need to determine connectivity and non-connectivity associated with the feature line 704G and the feature line 704E to mitigate challenges associated with the determination of the association of the feature line 704G and the feature line 704E. The system 102 may be further configured to solve the ML problem to a first probability for each geometry associated with the plurality of feature lines 704A-704G. The first probability may be indicative of a presence of the junction location associated with the feature line 704G in the one or more geometries (such as the feature line 704E) within a vicinity of the feature line 704G. In an embodiment, the system 102 may be configured to determine the first probability based on the set of connectivity features. Details about the set of connectivity attributes are provided, for example, in FIG. 2. In an embodiment, the system 102 may be configured to extend the feature line 704G from the end point 706A until an intersection of the feature 704G with the feature line 704E. The extension allows for a determination of the one or more geometries (such as the straight geometry, and the turning geometry) associated with the geographical region 702.

In an embodiment, the system 102 may be configured to determine an intersection of the feature line 704G with the feature line 704B, the feature line 704C, and the feature line 704D based on geometry data associated with the plurality of feature lines 704A-704G. The geometry data may include the lateral offset data associated with each of the one or more geometries, the orientation data associated with each of the one or more geometries, or the elevation data associated with each of one or more geometries. Details about the geometry data are provided, for example, in FIG. 2. In an embodiment, the system 102 may be configured to remove a part of the feature line 704G associated with the end point 706 of the feature line 704G. In an embodiment, the system 102 may be configured to remove the part of the feature line 704F associated with the end point 706 of the feature line 704G until an intersection of the feature line 704G with the feature line 704B.

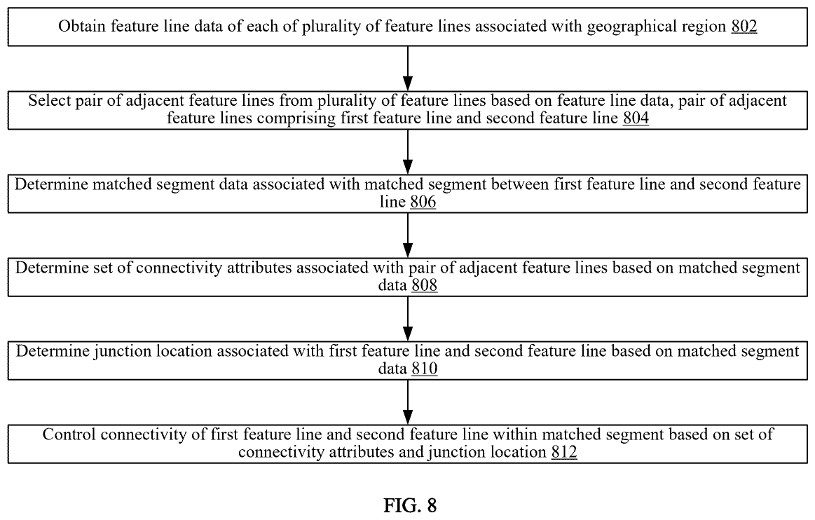

FIG. 8 illustrates a flowchart for implementation of another exemplary method 800 for controlling connectivity of the feature lines within the junction networks, in accordance with an embodiment of the disclosure. In various embodiments, the mapping platform 104 or the system 102 may perform one or more portions of the exemplary method 800 and may be implemented in, for instance, a chip set including a processor and a memory. As such, the mapping platform 104 or the system 102 may provide means for accomplishing various parts of the exemplary method 800, as well as means for accomplishing embodiments of other processes described herein in conjunction with other components of the system 102. Although the exemplary method 800 is illustrated and described as a sequence of steps, its contemplated that various embodiments of the exemplary method 800 may be performed in any order or combination and need not include all of the illustrated steps.

At 802, feature line data 106 of each of the plurality of feature lines 306A-306N may be obtained. In an embodiment, the system 102 may be configured to obtain the feature line data 106 of each of the plurality of feature lines 306A-306N associated with the first geographical region 302. In another embodiment, the processor 202 may be configured to obtain the feature line data 106 of each of the plurality of feature lines 306A-306N associated with the first geographical region 302. Details about the acquisition of the feature line data 106 are provided, for example, in FIG. 2.

At 804, the pair of adjacent feature lines may be selected based on the feature line data 106. In an embodiment, the system 102 may be configured to select the pair of adjacent feature lines based on the feature line data 106. The pair of the adjacent feature lines may include the first feature line 306A and the second feature line 306B. Additionally, the first feature line 306A and the second feature line 306B may have at least one intersection point. In another embodiment, the processor 202 may be configured to select the pair of adjacent feature lines based on the feature line data 106. Details about the selection of the adjacent feature lines are provided, for example, in FIG. 2.

At 806, the matched segment data associated with the matched segment 318 between the first feature line 306A and the second feature line 306B may be determined. In an embodiment, the system 102 may be further configured to determine the matched segment data associated with the matched segment 318 between the first feature line 306A and the second feature line 306B. Further, the distance between the first feature line 306A and the second feature line 306B within the matched segment 318 is less than the threshold. In an embodiment, the system 102 may be configured to determine the matched segment data based on the at least one intersection point. In another embodiment, the processor 202 may be configured to determine the matched segment data associated with the first feature line 306A and the second feature line 306B. Details about the matched segment data are provided, for example, in FIG. 2.

At 808, the set of connectivity attributes associated with the pair of adjacent feature lines may be determined based on the matched segment data. In an embodiment, the system 102 may be configured to determine the set of connectivity attributes associated with the pair of adjacent feature lines based on the matched segment data. In another embodiment, the processor 202 may be configured to determine the set of connectivity attributes associated with the pair of adjacent feature lines based on the matched segment data. Details about the determination of the set of connectivity attributes are provided, for example, in FIG. 2.

At 810, the junction location associated with the first feature line 306A and the second feature line 306B based on the matched segment data. In an embodiment, the system 102 may be configured to determine the junction location associated with the first feature line 306A and the second feature line 306B. In another embodiment, the processor 202 may be configured to determine the junction location associated with the first feature line 306A and the second feature line 306B. Details about the determination of the junction location are provided, for example, in FIGS. 5A, 5B, and 5C.

At 812, the connectivity of the first feature line 306A and the second feature line 306B within the matched segment 318 may be controlled based on the set of connectivity attributes and the junction location. In an embodiment, the system 102 may be configured to control the connectivity of the first feature line 306A and the second feature line 306B within the matched segment 318 based on the set of connectivity attributes and the junction location. In another embodiment, the system 102 may be configured to control the connectivity of the first feature line 306A and the second feature line 306B within the matched segment 318 based on the set of connectivity attributes and the junction location. Details about the controlling of the connectivity of the first feature line 306A and the second feature line 306B are provided, for example, in FIG. 3A.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
obtaining feature line data of each of a plurality of feature lines associated with a geographical region;
selecting a pair of adjacent feature lines from the plurality of feature lines based on the feature line data, the pair of adjacent feature lines comprising a first feature line and a second feature line;
determining matched segment data associated with a matched segment between the first feature line and the second feature line, wherein a distance between the first feature line and the second feature line within the matched segment is less than a threshold;
determining a set of connectivity attributes associated with the pair of adjacent feature lines based on the matched segment data;
determining a junction location associated with the first feature line and the second feature line based on the matched segment data; and
controlling a connectivity of the first feature line and the second feature line within the matched segment based on the set of connectivity attributes and the junction location.

2. The method of claim 1, wherein, the method further comprises:
identifying an end location associated with the first feature line;
determining a distance between the end location of the first feature line and a body location of the second feature line, wherein the body location corresponds to a closest point of the second feature line from the end location of the first feature line;
determining the junction location based on the distance, the end location of the first feature line and the body location of the second feature line; and
updating a part of at least one of: the first feature line, or the second feature line based on the set of connectivity attributes and the junction location, wherein the part corresponds to the matched segment.

3. The method of claim 1, further comprising:
determining geometry data associated with each of one or more geometries within the geographical region based on the feature line data;
identifying a geometry from the one or more geometries associated with each of the pair of adjacent feature lines based on the feature line data and the geometry data;
identifying at least one nearby geometry for each of the one or more geometries based on the geometry data, wherein the at least one nearby geometry is selected from the one or more geometries;
determining a set of geometry parameters for each of the one or more geometries based on the corresponding at least one nearby geometry;
determining whether each of the one or more geometries is associated with a junction network based on the corresponding set of geometry parameters; and
controlling the connectivity of the first feature line and the second feature line based on the corresponding geometry and the determination.

4. The method of claim 3, wherein each of the pair of adjacent feature lines is associated with a first geometry from the one or more geometries, and wherein the method further comprises:
determining the first geometry from the one or more geometries to be associated with the junction network based on the set of geometry parameters associated with the first geometry; and
preventing the connectivity of the first feature line and the second feature line associated with the fist geometry of the junction network at the at least one intersection point.

5. The method of claim 3, wherein the first feature line is associated with a first geometry from the one or more geometries and the second feature line is associated with a second geometry from the one or more geometries, and wherein the method further comprises:
determining the first geometry and the second geometry to be associated with the junction network based on a set of geometry parameters associated with the first geometry and a set of geometry parameters associated with the second geometry;
determining, using a machine learning (ML) model, a connectivity condition for controlling the connectivity of the matched segment based on the set of connectivity attributes; and
connectivity the first feature line and the second feature line within the matched segment based on the connectivity condition.

6. The method of claim 5, wherein the connectivity condition corresponds to one of: a first connectivity condition associated with removing one of: a part of the first feature line within the matched segment or a part of the second feature line within the matched segment, or a second connectivity condition associated with an extension of at least one of the part of the first feature line, or the part of the second feature line within the matched segment to connect the first feature line and the second feature line.

7. The method of claim 3, wherein at least one of the pair of adjacent feature lines is associated with a first geometry from the one or more geometries, and wherein the method further comprises:
determining the first geometry from the one or more geometries to not be associated with the junction network based on the set of geometry parameters associated with the first geometry;
determining a distance between the first feature line and the second feature line; and
controlling the connectivity of the first feature line and the second feature line associated with the first geometry based on a determination of a distance between the first feature line and the second feature line to be less than the threshold.

8. The method of claim 3, wherein the one or more geometries are associated with at least one of: an intersection geometry, a turning geometry, a splitting geometry, a connectivity geometry, or a straight geometry.

9. The method of claim 8, wherein the junction network is associated with at least one of: the intersection geometry, the turning geometry, the splitting geometry, or the connectivity geometry.

10. The method of claim 8, wherein the first feature line is associated with the straight geometry and the second feature line is associated with at least one of: the intersection geometry, the turning geometry, the splitting geometry, or the connectivity geometry.

11. The method of claim 3, further comprising:
obtaining map data associated with the geographical region;
segmenting each of the plurality of feature lines into one or more portions based on the feature line data;
identifying the one or more geometries within the geographical region based on the map data, the feature line data and the segmentation; and
associating each of the one or more portions of each of the plurality of feature lines with one of the one or more geometries.

12. The method of claim 3, wherein the geometry data comprises at least one of: lateral offset data associated with each of the one or more geometries, orientation data associated with each of the one or more geometries, or elevation data associated with each of one or more geometries.

13. The method of claim 1, wherein the set of connectivity attributes comprises at least one of: a heading feature associated with the first geometry and the second geometry, a length feature of the matched segment, a first distance feature associated with the first geometry and the second geometry, a second distance feature associated with the matched segment and a start location of the second geometry, a third distance feature associated with the matched segment and an end location of the second geometry, a fourth distance feature associated with the matched segment and an end location of the first geometry, a fifth distance feature associated with the matched segment and an end location of the first geometry, and an intersection feature associated with the intersection of the first geometry and the second geometry.

14. A system comprising:
a memory configured to store computer executable instructions; and
one or more processors configured to execute the instructions to:
obtain feature line data of each of a plurality of feature lines associated with a geographical region;
select a pair of adjacent feature lines from the plurality of feature lines based on the feature line data, the pair of adjacent feature lines comprising a first feature line and a second feature line, the pair of adjacent feature lines having at least one intersection point;
determine matched segment data associated with a matched segment between the first feature line and the second feature line based on the at least one intersection point, wherein a distance between the first feature line and the second feature line within the matched segment is less than a threshold;
determine a set of connectivity attributes associated with the pair of adjacent feature lines based on the matched segment data; and
control a connectivity of the first feature line and the second feature line within the matched segment based on the set of connectivity attributes.

15. The system of claim 14, wherein the one or more processors are further configured to:
determine geometry data associated with each of one or more geometries within the geographical region based on the feature line data;
identify a geometry from the one or more geometries associated with each of the pair of adjacent feature lines based on the feature line data and the geometry data;
identify at least one nearby geometry for each of the one or more geometries based on the geometry data, wherein the at least one nearby geometry is selected from the one or more geometries;
determine a set of geometry parameters for each of the one or more geometries based on the corresponding at least one nearby geometry;
determine whether each of the one or more geometries is associated with a junction network based on the corresponding set of geometry parameters; and
control the connectivity of the first feature line and the second feature line based on the corresponding geometry and the determination.

16. The system of claim 15, wherein each of the pair of adjacent feature lines is associated with a first geometry from the one or more geometries, and wherein the one or more processors are further configured to:
determine the first geometry from the one or more geometries to be associated with the junction network based on the set of geometry parameters associated with the first geometry; and
prevent the connectivity of the first feature line and the second feature line associated with the first geometry of the junction network at the at least one intersection point.

17. The system of claim 15, wherein the first feature line is associated with a first geometry from the one or more geometries and the second feature line is associated with a second geometry from the one or more geometries, and wherein the one or more processors are further configured to:
determine the first geometry and the second geometry to be associated with the junction network based on a set of geometry parameters associated with the first geometry and a set of geometry parameters associated with the second geometry;
determine, using a machine learning (ML) model, a connectivity condition for controlling the connectivity of the matched segment based on the set of connectivity attributes; and
connect the first feature line and the second feature line within the matched segment based on the connectivity condition.

18. The system of claim 17, wherein the connectivity condition corresponds to one of: a first connectivity condition associated with removing one of: a part of the first feature line within the matched segment or a part of the second feature line within the matched segment, or a second connectivity condition associated an extension of at least one of the part of the first feature line, or the part of the second feature line within the matched segment to connect the first feature line and the second feature line.

19. The system of claim 15, wherein at least one of the pair of adjacent feature lines is associated with a first geometry from the one or more geometries, and wherein the one or more processors are further configured to:
determine the first geometry from the one or more geometries to not be associated with the junction network based on the set of geometry parameters associated with the first geometry;
determine a distance between the first feature line and the second feature line; and
control the connectivity of the first feature line and the second feature line associated with the first geometry based on a determination of a distance between the first feature line and the second feature line to be less than the threshold.

20. A computer programmable product comprising a non-transitory computer readable medium having stored thereon computer executable instructions, which when executed by one or more processors, cause the one or more processors to carry out operations for controlling connectivity of feature lines, the operations comprising:
obtaining feature line data of each of a plurality of feature lines associated with a geographical region;
selecting a pair of adjacent feature lines from the plurality of feature lines based on the feature line data, the pair of adjacent feature lines comprising a first feature line and a second feature line, the pair of adjacent feature lines having at least one intersection point;
determining matched segment data associated with a matched segment between the first feature line and the second feature line based on the at least one intersection point, wherein a distance between the first feature line and the second feature line within the matched segment is less than a threshold;
determining a set of connectivity attributes associated with the pair of adjacent feature lines based on the matched segment data; and
controlling a connectivity of the first feature line and the second feature line within the matched segment based on the set of connectivity attributes.
